(19) United States
(12) Patent Application Publication
(10) Pub. No.: US 2023/0106700 A1
(43) Pub. Date: Apr. 6, 2023

(54) BICYCLE LOCK

(71) Applicant: YU-PIN LIN, Tainan (TW)

(72) Inventor: YU-PIN LIN, Tainan (TW)

(73) Assignee: YU-PIN LIN, Tainan (TW)

(21) Appl. No.: 17/449,949

(22) Filed: Oct. 5, 2021

(51) Int. Cl. E05B 71/00

(52) U.S. Cl. CPC E05B 71/00

(57) ABSTRACT

A bicycle lock has a horseshoe lock with a base; and a steel cable. The base has a lock seat, a shell disposes on the base, the shell has a cover to hood on the lock seat, a lock core disposes on the lock seat, a swivel seat assembles on the lock core, a torsion spring disposes between the lock core and the swivel seat, a lock column disposes in an accommodating groove of the shell, a stretch spring disposes in the accommodating groove and sleeves on the lock column and the shell, a butt member disposes in the accommodating groove, a first compression spring disposes in the accommodating groove and sleeves on the shell and in the butt member, a second compression spring disposes in an accommodating groove of the lock seat. The steel cable has a lock rod to insert into the shell and the lock seat.

### BACKGROUND OF THE INVENTION

### Field of Invention

The invention relates to a bicycle lock, and more particularly to a steel cable that can be directly locked on a horseshoe lock without the need for additional padlock.

### Related Art

Bicycles are usually equipped with a lock to prevent the bicycles from being stolen, the conventional bicycle lock (horseshoe lock, also known as ring lock) is used to lock on the wheel of the bicycle so that the wheel of the bicycle cannot be rotated, and the horseshoe lock is fixed on the frame of the bicycle. When the bicycle needs to be locked, the C-shaped lock column of the horseshoe lock is locked on the wheel of the bicycle to complete the locking action. However, the conventional horseshoe lock can only be locked on the wheel rim of the bicycle, and the bicycle cannot be connected to other fixed objects (such as pillar, railing, etc.), so a steel cable and a padlock that can be wound around the fixed object and the bicycle frame are required to connect and lock the bicycle to the fixed object in order to prevent the bicycle from being carried away directly by thieves. Therefore, it is conventionally known that two locks must be used at the same time to prevent the bicycle from being stolen, and it is time-consuming and troublesome to use when locking and unlocking.

### SUMMARY OF THE INVENTION

A main object of the invention is to provide a bicycle lock capable of effectively solving the drawbacks of the conventional bicycle lock in usage.

The bicycle lock of the invention is mainly provided with a horseshoe lock and a steel cable. The horseshoe lock is provided with a base, one end portion of the base is provided with a lock seat thereon, the lock seat is provided with a chamber, a side wall surface of the lock seat is provided with an accommodating groove, a connecting hole is provided between the accommodating groove and the chamber to communicate, a through hole communicating with the chamber is provided on another side wall of the lock seat, a shell is fixedly disposed on the base, inside the shell is provided with a through accommodating groove, an outer side wall surface of the shell is provided with a sliding groove, inside the accommodating groove of the shell is provided with a fixing rod and a positioning rod, one end portion of the shell is provided with a cover to hood on the lock seat, the cover is provided with a lock core perforation corresponding to the chamber of the lock seat, a side wall surface of the cover is provided with an insertion hole corresponding to the accommodating groove of the lock seat, a lock core is disposed in the chamber of the lock seat and penetrates through the lock core perforation of the shell, an outer end surface of the lock core is provided with a key insertion hole, the lock core is convexly provided with a rotating shaft, the rotating shaft is provided with a pin hole, an inner wall surface of the lock core is provided with an embedding hole, a swivel seat is assembled on the rotating shaft of the lock core, the swivel seat is provided with a shaft hole for inserting the rotating shaft, a wall surface of the swivel seat is provided with a first groove, a second groove and a positioning slot, the positioning slot is communicated with the shaft hole, a positioning pin is penetrated into the positioning slot and inserted into the pin hole of the rotating shaft, the swivel seat is provided with an embedding hole, a first steel ball is disposed in the first groove of the swivel seat and the through hole of the lock seat, a second steel ball is disposed in the second groove of the swivel seat and the connecting hole of the lock seat, a torsion spring is disposed between the lock core and the swivel seat, one end of the torsion spring is embedded in the embedding hole of the lock core, another end of the torsion spring is embedded in the embedding hole of the swivel seat, a lock column is disposed in the accommodating groove of the shell, an outer end portion of the lock column is provided with a lock groove, an outer wall surface of the lock column is provided with a push handle, the push handle protrudes from the sliding groove of the shell, an inner end portion of the lock column is provided with a perforation, a stretch spring is assembled on the lock column, one end of the stretch spring is sleeved in the perforation of the lock column, another end of the stretch spring is sleeved on the fixing rod of the shell, a butt member is disposed in the accommodating groove of the shell and located on an inner wall surface of the lock seat, one end of the butt member is provided with an embedding groove, the butt member is provided with a guide chute, the positioning rod of the shell is inserted in the guide chute, a first compression spring is provided in the accommodating groove of the shell, one end of the first compression spring is sleeved on the fixing rod of the shell, another end of the first compression spring is disposed in the embedding groove of the butt member, a second compression spring is disposed in the accommodating groove of the lock seat, one end of the steel cable is provided with a lock rod, the lock rod is inserted into the insertion hole of the shell and the accommodating groove of the lock seat, the lock rod is provided with a ring groove, and another end of the steel cable is provided with a sleeve ring.

In the bicycle lock of the invention, wherein the shell and the base are fixed as one body by a plurality of rivets.

In the bicycle lock of the invention, wherein the steel cable can be replaced with a chain.

The bicycle lock of the invention has the advantages that the steel cable can be directly locked on the lock seat of the horseshoe lock, no additional padlock is required, a cost of purchasing padlock can be saved, and locking is extremely convenient and fast to achieve optimal anti-theft efficacy.

### BRIEF DESCRIPTION OF THE DRAWINGS

FIG. 1 is a perspective view of an embodiment of the invention;

FIG. 2 is a perspective exploded view of a horseshoe lock of an embodiment of the invention;

FIG. 3 is a combined cross-sectional view of an embodiment of the invention;

FIG. 4 is a cross-sectional view of locking of the horseshoe lock of an embodiment of the invention;

FIG. 5 is a cross-sectional view of the horseshoe lock and a steel cable being locked at the same time of an embodiment of the invention; and

FIG. 6 is a perspective view of the horseshoe lock and the steel cable being locked at the same time of an embodiment of the invention.

### DETAILED DESCRIPTION OF THE INVENTION

Regarding the technical means adopted by the invention to achieve the above-mentioned object and efficacy, a preferred and feasible embodiment is explained in details hereunder in conjunction with the figures.

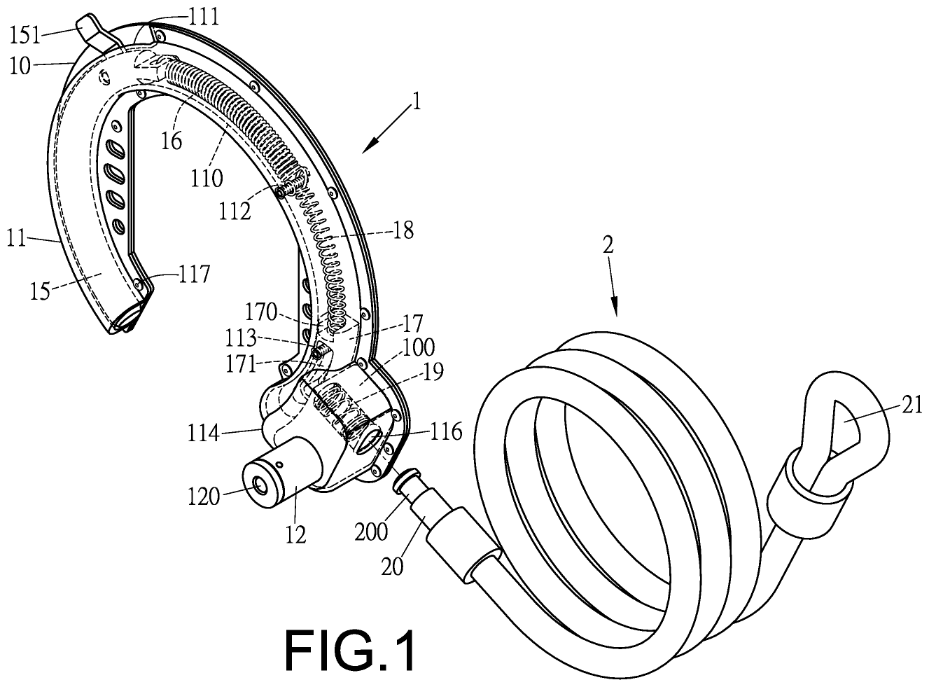

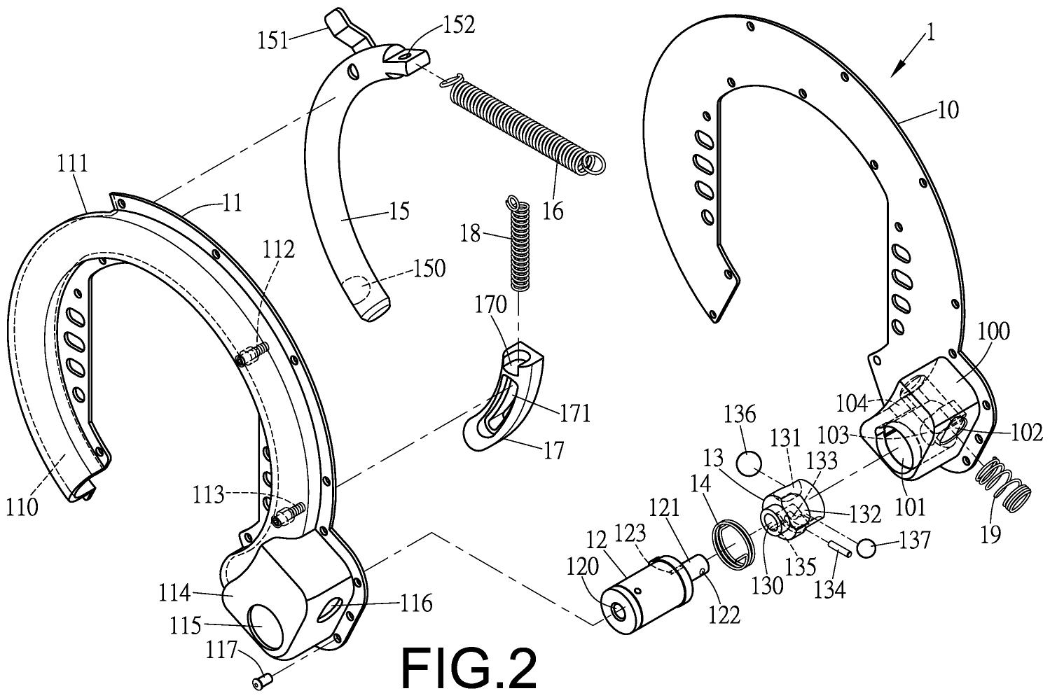

For an embodiment of the invention, please refer to FIGS. 1 to 3. A horseshoe lock 1 and a steel cable 2 are mainly provided. The horseshoe lock 1 is provided with a base 10, the base 10 is formed in a C shape, one end portion of the base 10 is provided with a lock seat 100 thereon, the lock seat 100 is provided with a chamber 101, a side wall surface of the lock seat 100 is provided with an accommodating groove 102, a connecting hole 103 is provided between the accommodating groove 102 and the chamber 101 to communicate, a through hole 104 communicating with the chamber 101 is provided on another side wall of the lock seat 100, a shell 11 is fixedly disposed on the base 10, the shell 11 is also formed in a C shape corresponding to the base 10, inside the shell 11 is provided with a through accommodating groove 110, a front section of an outer side wall surface of the shell 11 is provided with a sliding groove 111, inside the accommodating groove 110 of the shell 11 is provided with a fixing rod 112 and a positioning rod 113, one end portion of the shell 11 is provided with a cover 114 to hood on the lock seat 100, the cover 114 is provided with a lock core perforation 115 corresponding to the chamber 101 of the lock seat 100, a side wall surface of the cover 114 is provided with an insertion hole 116 corresponding to the accommodating groove 102 of the lock seat 100, the shell 11 and the base 10 are fixed as one body by a plurality of rivets 117, a lock core 12 is disposed in the chamber 101 of the lock seat 100 and penetrates through the lock core perforation 115 of the shell 11, an outer end surface of the lock core 12 is provided with a key insertion hole 120, the lock core 12 is convexly provided with a rotating shaft 121, the rotating shaft 121 is provided with a pin hole 122, an inner wall surface of the lock core 12 is provided with an embedding hole 123, a swivel seat 13 is assembled on the rotating shaft 121 of the lock core 12, the swivel seat 13 is provided with a shaft hole 130 for inserting the rotating shaft 121, a wall surface of the swivel seat 13 is provided with a first groove 131, a second groove 132 and a positioning slot 133, the positioning slot 133 is communicated with the shaft hole 130, a positioning pin 134 is penetrated into the positioning slot 133 and inserted into the pin hole 122 of the rotating shaft 121, the swivel seat 13 is provided with an embedding hole 135, a first steel ball 136 is disposed in the first groove 131 of the swivel seat 13 and the through hole 104 of the lock seat 100, a second steel ball 137 is disposed in the second groove 132 of the swivel seat 13 and the connecting hole 103 of the lock seat 100, a torsion spring 14 is disposed between the lock core 12 and the swivel seat 13, one end of the torsion spring 14 is embedded in the embedding hole 123 of the lock core 12, another end of the torsion spring 14 is embedded in the embedding hole 135 of the swivel seat 13, a lock column 15 is disposed in the accommodating groove 110 of the shell 11, an end portion of the lock column 15 is provided with a lock groove 150, an outer wall surface of the lock column 15 is provided with a push handle 151, another end portion of the lock column 15 is provided with a perforation 152, a stretch spring 16 is assembled on the lock column 15, one end of the stretch spring 16 is sleeved in the perforation 152 of the lock column 15, another end of the stretch spring 16 is sleeved on the fixing rod 112 of the shell 11, a butt member 17 is disposed in the accommodating groove 110 of the shell 11 and located on an inner wall surface of the lock seat 100, one end of the butt member 17 is provided with an embedding groove 170, the butt member 17 is provided with a guide chute 171, the positioning rod 113 of the shell 11 is inserted in the guide chute 171, a first compression spring 18 is provided in the accommodating groove 110 of the shell 11, one end of the first compression spring 18 is sleeved on the fixing rod 112 of the shell 11, another end of the first compression spring 18 is disposed in the embedding groove 170 of the butt member 17, a second compression spring 19 is disposed in the accommodating groove 102 of the lock seat 100, one end of the steel cable 2 is provided with a lock rod 20, the lock rod 20 is provided with a ring groove 200, and another end of the steel cable 2 is provided with a sleeve ring 21, and the steel cable 2 can also be disposed as a chain, thus a bicycle lock structure is formed.

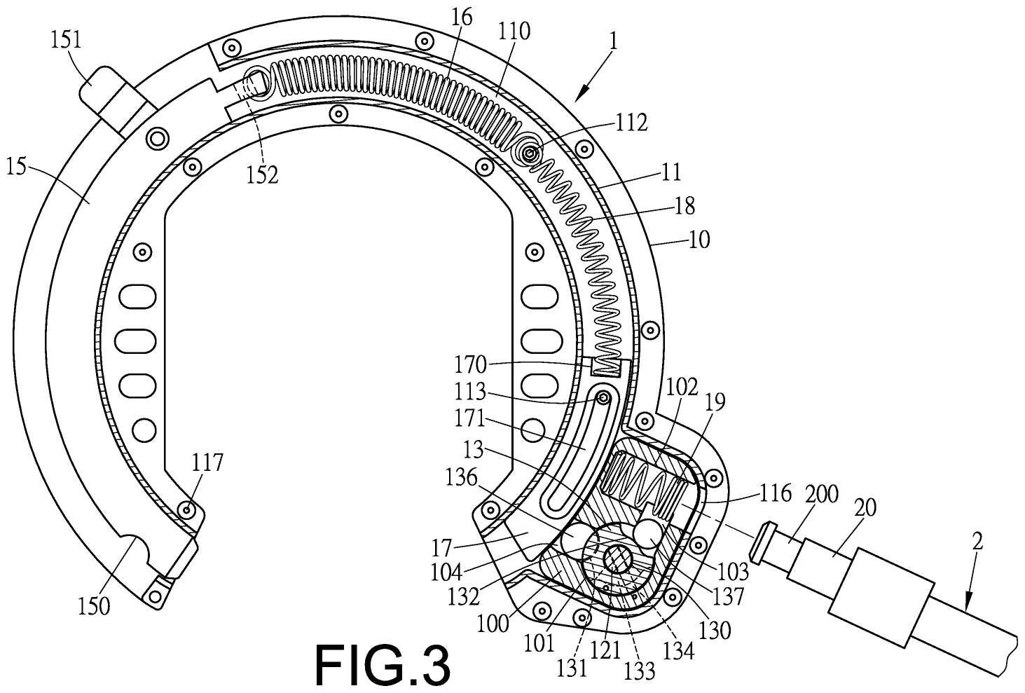

Please refer to FIGS. 1 to 3 for assembling of the invention. Firstly, the torsion spring 14 is assembled on the rotating shaft 121 of the lock core 12, and then the swivel seat 13 is assembled on the rotating shaft 121 of the lock core 12 to embed one of the ends of the torsion spring 14 in the embedding hole 123 of the lock core 12, and embed the other end of the torsion spring 14 in the embedding hole 135 of the swivel seat 13, and the rotating shaft 121 is inserted into the shaft hole 130 of the swivel seat 13. Then the positioning pin 134 is inserted into the positioning slot 133 of the swivel seat 13 and the pin hole 122 of the rotating shaft 121, the swivel seat 13, the torsion spring 14 and the lock core 12 are assembled into one body, the first steel ball 136 is placed into the first groove 131 of the swivel seat 13, and the second steel ball 137 is placed into the second groove 132 of the swivel seat 13. Then the swivel seat 13, the torsion spring 14, the lock core 12, the first steel ball 136 and the second steel ball 137 are placed into the chamber 101 of the lock seat 100 together, a part of the first steel ball 136 is disposed in the through hole 104 of the lock seat 100, and a part of the second steel ball 137 is disposed in the connecting hole 103 of the lock seat 100 (as shown in FIG. 3). The second compression spring 19 is placed in the accommodating groove 102 of the lock seat 100, an outer end portion of the second compression spring 19 abuts and positions the second steel ball 137 toward the connecting hole 103, one of the ends of the stretch spring 16 is sleeved into the perforation 152 of the lock column 15, the lock column 15 and the stretch spring 16 are placed into the accommodating groove 110 of the shell 11 together, the other end of the stretch spring 16 is sleeved on the fixing rod 112 of the shell 11, and one of the ends of the first compression spring 18 is sleeved on the fixing rod 112 of the shell 11. The butt member 17 is disposed in the accommodating groove 110 of the shell 11, the other end of the first compression spring 18 is disposed in the embedding groove 170 of the butt member 17, and then the shell 11 is assembled on the base 10. The cover 114 on the shell 11 is hooded on the lock seat 100, the shell 11 is riveted and fixed with the base 10 by the rivets 117, and a side wall surface of the butt member 17 abuts and positions the first steel ball 136 toward the lock seat 100. In this way, assembly of the horseshoe lock 1 is completed.

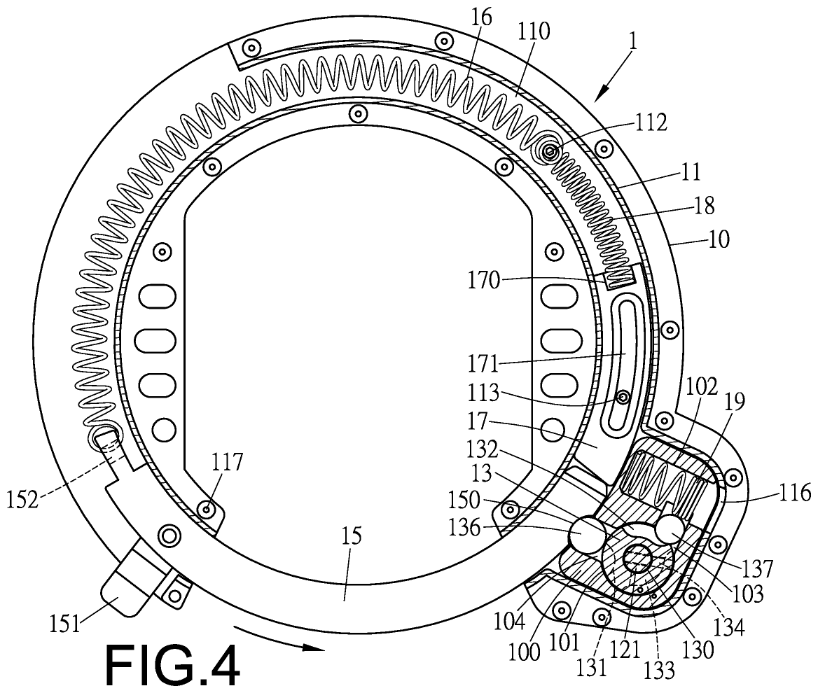

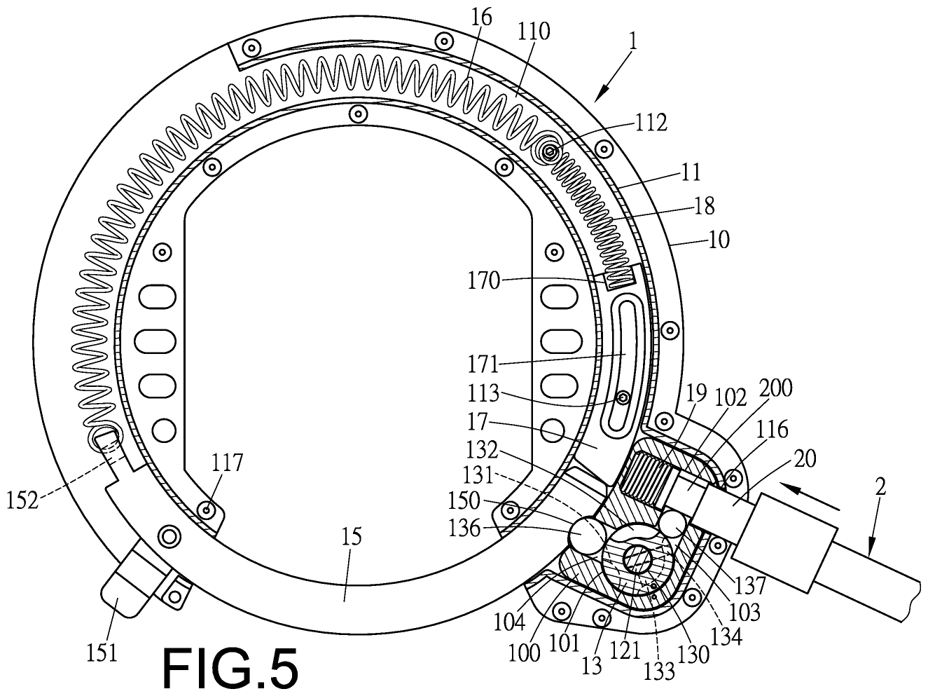

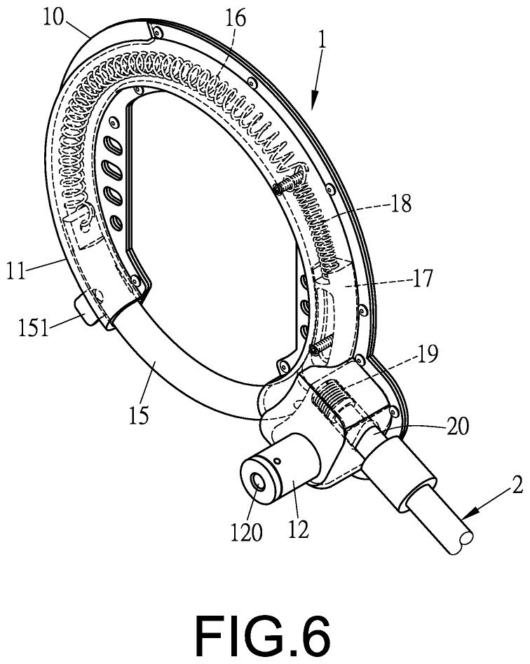

Please refer to FIGS. 3 to 6 for usage of the invention. When the horseshoe lock 1 of the invention is fixed on a frame of a bicycle and needs to be locked, the lock column 15 is pushed away from the accommodating groove 110 at one end of the shell 11 by pulling the push handle 151 on the horseshoe lock 1, the stretch spring 16 is pulled to be in an elastic stretched state, and the outer end portion of the lock column 15 is inserted into the accommodating groove 110 at another end of the shell 11. The lock column 15 butts and pushes against the butt member 17 to move inward, the butt member 17 compresses the first compression spring 18 so that the first compression spring 18 is in an elastic compressed state, and when the lock groove 150 of the lock column 15 corresponds to a position of the first steel ball 136, the first steel ball 136 is capable of moving outward and embedding in the lock groove 150. At this point, the swivel seat 13 is slightly rotated by partial elastic recovery of the torsion spring 14 (as shown in FIG. 4), the first groove 131 of the swivel seat 13 is separated from a position of the first steel ball 136, and the wall surface of the swivel seat 13 butts against the first steel ball 136, and the first steel ball 136 is capable of locking and positioning the lock column 15 to form a first stage of locking of the horseshoe lock 1. The steel cable 2 is wound around a fixed object (such as pillar or railing, etc.) to be fixed with the bicycle, the lock rod 20 is inserted into the sleeve ring 21, and then the lock rod 20 is inserted into the insertion hole 116 of the shell 11 and the accommodating groove 102 of the lock seat 100 of the horseshoe lock 1. By inserting the lock rod 20 into the accommodating groove 102 and compressing the second compression spring 19 to be in an elastic compressed state, the second compression spring 19 no longer butts against the second steel ball 137, the second steel ball 137 is capable of moving toward the accommodating groove 102 and disposing into the ring groove 200 of the lock rod 20. At this point, the swivel seat 13 is again driven by elastic restoring force of the torsion spring 14, the swivel seat 13 rotates again, the second groove 132 of the swivel seat 13 is separated from a position of the second steel ball 137, and the wall surface of the swivel seat 13 butts against the second steel ball 137 (as shown in FIG. 5) to lock and position the lock rod 20 of the steel cable 2 to form a second stage of locking of the steel cable 2. In this way, the steel cable 2 of the invention can be directly locked on the lock seat 100 of the horseshoe lock 1, no additional padlock is required, a cost of purchasing padlock can be saved, and locking is extremely convenient and fast to achieve optimal anti-theft locking efficacy.

When the invention needs to be unlocked, simply insert a key into the key insertion hole 120 of the lock core 12 and rotate the key, so that the rotating shaft 121 drives the swivel seat 13 to rotate, the first groove 131 of the swivel seat 13 corresponds to the first steel ball 136, the second groove 132 corresponds to the second steel ball 137, the first steel ball 136 and the second steel ball 137 are no longer abutted by the wall surface of the swivel seat 13 and can be retracted in the first groove 131 and the second groove 132 respectively, the first steel ball 136 is no longer embedded in the lock groove 150 of the lock column 15, and the lock column 15 is pulled by elastic recovery of the stretch spring 16 and retracted in the accommodating groove 110 of the shell 11. The butt member 17 is no longer butted by the lock column 15 and is pushed back to an original position by elastic recovery of the first compression spring 18, the first steel ball 136 is again butted and positioned in the through hole 104, and the second steel ball 137 is retracted in the second groove 132 of the swivel seat 13 and is no longer butted in the ring groove 200 of the lock rod 20 of the steel cable 2. The second compression spring 19 recovers elastically to push the lock rod 20 outward to detach from the horseshoe lock 1, and the outer end portion of the second compression spring 19 butts against the second steel ball 137 and positions the second steel ball 137 in the connecting hole 103 again. In this way, unlocking action can be completed, and the invention is very convenient to use.

In summary, the invention has indeed achieved the intended object and efficacy of use, and is more ideal and practical than the prior art. However, the above-mentioned embodiment is merely specific descriptions of the preferred embodiment of the invention, the embodiment is not intended to limit the claims of the invention, and all other equivalent changes and modifications completed without departing from the technical means disclosed in the invention should be included in the claims covered by the invention.

What is claimed is:

1. A bicycle lock comprising:
a horseshoe lock, the horseshoe lock being provided with a base, one end portion of the base being provided with a lock seat thereon, the lock seat being provided with a chamber, a side wall surface of the lock seat being provided with an accommodating groove, a connecting hole being provided between the accommodating groove and the chamber to communicate, a through hole communicating with the chamber being provided on another side wall of the lock seat, a shell being fixedly disposed on the base, inside the shell being provided with a through accommodating groove, an outer side wall surface of the shell being provided with a sliding groove, inside the accommodating groove of the shell being provided with a fixing rod and a positioning rod, one end portion of the shell being provided with a cover to hood on the lock seat, the cover being provided with a lock core perforation corresponding to the chamber of the lock seat, a side wall surface of the cover being provided with an insertion hole corresponding to the accommodating groove of the lock seat, a lock core being disposed in the chamber of the lock seat and penetrating through the lock core perforation of the shell, an outer end surface of the lock core being provided with a key insertion hole, the lock core being convexly provided with a rotating shaft, the rotating shaft being provided with a pin hole, an inner wall surface of the lock core being provided with an embedding hole, a swivel seat being assembled on the rotating shaft of the lock core, the swivel seat being provided with a shaft hole for inserting the rotating shaft, a wall surface of the swivel seat being provided with a first groove, a second groove and a positioning slot, the positioning slot communicating with the shaft hole, a positioning pin penetrating into the positioning slot and inserting into the pin hole of the rotating shaft, the swivel seat being provided with an embedding hole, a first steel ball being disposed in the first groove of the swivel seat and the through hole of the lock seat, a second steel ball being disposed in the second groove of the swivel seat and the connecting hole of the lock seat, a torsion spring being disposed between the lock core and the swivel seat, one end of the torsion spring being embedded in the embedding hole of the lock core, another end of the torsion spring being embedded in the embedding hole of the swivel seat, a lock column being disposed in the accommodating groove of the shell, an outer end portion of the lock column being provided with a lock groove, an outer wall surface of the lock column being provided with a push handle, the push handle protruding from the sliding groove of the shell, an inner end portion of the lock column being provided with a perforation, a stretch spring being assembled on the lock column, one end of the stretch spring being sleeved in the perforation of the lock column, another end of the stretch spring being sleeved on the fixing rod of the shell, a butt member being disposed in the accommodating groove of the shell and located on an inner wall surface of the lock seat, one end of the butt member being provided with an embedding groove, the butt member being provided with a guide chute, the positioning rod of the shell being inserted in the guide chute, a first compression spring being provided in the accommodating groove of the shell, one end of the first compression spring being sleeved on the fixing rod of the shell, another end of the first compression spring being disposed in the embedding groove of the butt member, a second compression spring being disposed in the accommodating groove of the lock seat; and
a steel cable, one end of the steel cable being provided with a lock rod, the lock rod inserting into the insertion hole of the shell and the accommodating groove of the lock seat, the lock rod being provided with a ring groove, and another end of the steel cable being provided with a sleeve ring.

2. The bicycle lock as claimed in claim 1, wherein the shell and the base are fixed as one body by a plurality of rivets.

3. The bicycle lock as claimed in claim 1, wherein the steel cable can be replaced with a chain.
